(19) United States
(12) Patent Application Publication
(10) Pub. No.: US 2020/0073980 A1
(43) Pub. Date: Mar. 5, 2020

(54) MAINTAINING DOCKETING DATA INTEGRITY

(71) Applicant: Black Hills IP Holdings, LLC, Minneapolis, MN (US)

(72) Inventors: Steven W. Lundberg, Edina, MN (US); Thomas G. Marlow, Cape Elizabeth, ME (US)

(21) Appl. No.: 16/118,236

(22) Filed: Aug. 30, 2018

(51) Int. Cl. G06F 17/30

(52) U.S. Cl. CPC G06F 17/30377; G06F 17/3033

(57) ABSTRACT

Methods and systems for maintaining docketing data integrity are provided. The method includes retrieving, from a storage device, a first data structure that includes docketing information associated with a matter. Receiving new docketing information associated with the matter. Updating the docketing information associated with the matter with the new docketing information. Generating a second data structure that includes the updated docketing information and a hash corresponding to the docketing information included in the first data structure. Linking the first and second data structures. Storing the linked first and second data structures on the storage device.

### BACKGROUND

The management of patent portfolios involves multiple stages of the patent lifecycle. Initially, a decision is made as to what inventions are worth the investment of filing a patent application. Then, each filed patent application goes through prosecution with the patent office. Finally, for each patent that is allowed, maintenance fees must be paid at a variety of intervals to keep the patent in force. Patent management tools are used by companies and law firms for active patent matters (e.g., unfiled, pending and issued patent matters) as well as inactive patent matters (e.g., expired, abandoned or closed patent matters) to enable users to efficiently manage patent matters throughout the patent lifecycle.

Many patent management tools include patent docketing capabilities for tracking important due dates for PTO related deadlines and providing a document repository for PTO related correspondences and documents. The patent docketing process may involve (1) storing all key intellectual property information in a centralized and consolidated database; (2) providing access to critical information from documents (e.g., correspondences between law firms and the U.S. PTO, or law firms and clients) and deadlines (e.g., PTO deadlines and non-PTO deadlines); and (3) providing customizable workflows for streaming and automating the patent management processes throughout the patent lifecycle.

Companies and law firms rely on the accuracy of the information contained in the patent management tools to make informed decisions. Accordingly, the ability to modify and enter the data for various matters in these patent management tools is typically restricted to certain organizations or individuals or by limiting access to the tools through certain applications or APIs. Although the ability to modify and enter the data is restricted, sometimes data in these tools can become corrupt or may be changed surreptitiously thereby hindering the integrity of the data which reduces the overall reliability of the tools and the data.

### BRIEF DESCRIPTION OF DRAWINGS

Some embodiments are illustrated by way of example and not limitation in the figures of the accompanying drawings in which:

FIG. 1 is a system component diagram, according to an example embodiment.

FIG. 2 is a block diagram of a patent management system, according to an example embodiment.

FIGS. 3A-3C are block diagrams showing processes for maintaining data integrity in the patent management system, according to example embodiments.

FIGS. 4 and 5 are depictions of user interfaces, according to an example embodiment.

FIGS. 6A and 6B are depictions of data structures used to maintain data integrity in the patent management system, according to an example embodiment.

FIG. 7 is a block diagram of machine in the example form of a computer system within which a set of instructions, for causing the machine to perform any one or more of the methodologies herein discussed, may be executed.

### DETAILED DESCRIPTION

Techniques set forth in this specification enhance reliability and maintain integrity of docketing information stored in a patent management system. Particularly, the embodiments described herein use data structures in the form of a blockchain to maintain docketing information. New data structures are added to the blockchain as changes are made to the docketing information. Each data structure in the blockchain keeps a hash, generated using a cryptographic key, of the docketing information of a previous blockchain data structure and a hash of its own docketing information. Keeping these hash values in the blockchain data structures enables detection of docketing information that has been compromised because a hash of such compromised data would no longer match the corresponding hash in the blockchain data structure.

Two embodiments are described for maintaining docketing information integrity using a blockchain of data structures. In both embodiments, the blockchain data structure are updated and maintained in a similar manner where a new blockchain data structure is added and linked to the blockchain as docketing information is added or updated.

In one embodiment, the docketing information for a given matter is stored in two places. The docketing information is stored in a database of the patent management system and is also stored in data structures of a blockchain. In this embodiment, the blockchain data structures act as a backup of the docketing information stored in the patent management system database. The blockchain data structures can be routinely or periodically checked for data integrity of the data stored in the patent management system database. For example, docketing information for a given matter or portfolio is obtained from the database of the patent management system and a hash is generated for this obtained docketing information. The hash is also obtained from the blockchain data structure corresponding to the matter or portfolio and compared to the hash generated based on the docketing information obtained from the patent management system database. If the two hash values do not match, the docketing information stored in the patent management system database is determined to be compromised. In such cases, this data can be replaced or repaired using the corresponding docketing information stored in the blockchain data structure. Alternatively, a notification may be provided to a system operator to manually check, verify and correct the information for the matter or portfolio in the patent management system.

In a second embodiment, the docketing information stored in the blockchain data structures is used as the only source of the docketing data for the patent management system. These blockchain data structures can be routinely or periodically checked for data integrity. For example, docketing information for a given matter or portfolio is obtained from the latest blockchain data structure corresponding to the matter or portfolio. A hash is generated for this obtained docketing information and compared to the previously stored hash in the latest blockchain data structure. If the two hash values do not match, the docketing information stored in the latest blockchain data structure is determined to be compromised. In such cases, the previous blockchain data structure for the matter or portfolio is accessed and checked for data integrity in the same or similar way. If the previous blockchain data structure for the matter or portfolio is determined to not contain compromised docketing information (e.g., because the hash value generated based on the docketing information in the previously blockchain data structure matches the hash value stored in that blockchain data structure), the previous blockchain data structure is used as the source of docketing data for the matter or portfolio in the patent management system instead of the latest data structure in the blockchain. The latest data structure in the blockchain can be discarded. Alternatively, a system operator can be notified to manually check, verify and correct the information for the matter or portfolio in the patent management system.

The systems and methods set forth in this specification are described in relation to a patent management system (such as a patent docketing system) and patent matters, but it will be understood that the present invention could equally be applied to other forms of intellectual property (trademarks, copyright, registered designs, and the like). Moreover, the term “patent” is not intended to be limited to an issued patent, but may include a pending patent application or unfiled application or invention disclosure. The term “user” is intended to cover any person interacting with the patent management system. A user may be an inventor, portfolio manager, business manager, patent attorney, patent paralegal, or patent docketing personnel, for example.

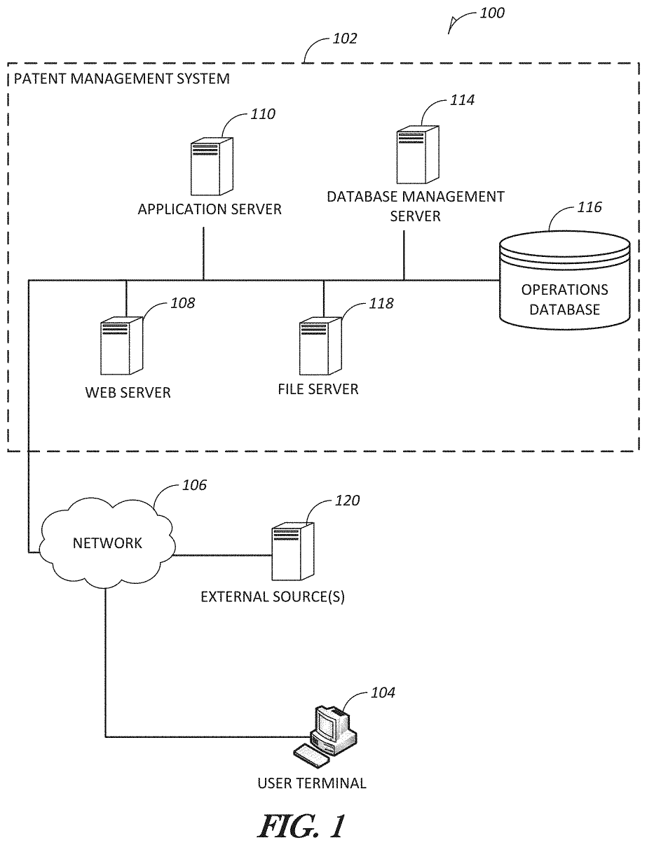

FIG. 1 is a schematic view of computer network system 100 according to various embodiments. The computer network system 100 includes patent management system 102 and user terminal 104 communicatively coupled via network 106. In an embodiment, patent management system 102 includes web server 108, application server 110, and database management server 114 which may be used to manage at least operations database 116 and file server 118. Patent management system 102 may be implemented as a distributed system, for example one or more elements of the patent management system 102 may be located across a wide-area network (WAN) from other elements of patent management system 102. As another example, a server (e.g., web server 108, file server 118, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based applications and presentation of information. For example, application server 110 may consist of scripts, applications, or library files that provide primary or auxiliary functionality to web server 108 (e.g., multimedia, file transfer, or dynamic interface functions). Applications may include code, which when executed by one or more processors, run the software components of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in patent management system 102, may provide a user-interface to user terminal 104 for interacting with the tools of patent management system 102 stored in application server 110. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 104 may be a personal computer or mobile device. in an embodiment, user terminal 104 includes a client program to interface with patent management system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a compilation, represent an “operations database.” Sub-databases in such a configuration may include a matter database a portfolio database, a user database, a mapping database, a blockchain database and an analytics database. Operations database 116 may be implemented as a relational database, a centralized database, a distributed database, an object oriented database, or a flat database in various embodiments. In some embodiments, the blockchain database may be combined with the matter and portfolio database to store docketing information in blockchain data structures as the single source of docketing information for the patent management system. In other embodiments, the blockchain database may store docketing information in blockchain data structures as a backup (or duplicate information) of the data stored in matter or portfolio database.

In various embodiments, the patent management system framework may have a base organization unit of a matter. In various embodiments, a matter is an issued patent or patent application that includes one or more patent claims. In an embodiment, a matter is generally identified by its patent number or publication number. Identification may mean either identification as it relates to a user of the patent management system or within the patent management system. Thus, a user may see a matter listed as its patent number while internally a database of the patent management system may identify it by a random number.

One or more matters may be grouped together to form a portfolio. A matter may also be associated with one or more other matters in a family. A family member may be a priority matter, a continuing (e.g., continuation, divisional) matter, or foreign counter-part member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various embodiments, a matter may be associated with more than one portfolio by creating multiple entries in the portfolio database, one for each portfolio that the matter is associated with. In other embodiments, one or more patent reference documents may be associated with a patent by creating multiple entries in the patent database, for example. The structure of the database and format and data field titles are for illustration purposes and other structures, names, or formats may be used. Additionally, further associations between data stored in the databases may be created as discussed further herein. For example, docketing information for each matter or portfolio may be stored in a data structure, such as a block in a blockchain or ledger entry in a ledger, and linked to previous versions of the docketing information stored in earlier data structures. As referred to herein, docketing information includes bibliographic information, docketing activity information, deadline information, or documents associated with a given matter or portfolio or any other information stored in the patent management system databases.

During operation of patent management system 102, data from multiple data sources (internal and external) may be imported into or accessed by the operations database 116. Internal sources may include data from the various tools of the patent management system. External sources 120 may include websites or databases associated with foreign and domestic patent offices, assignment databases, WIPO, and INPADOC. In various embodiments, the data is scraped and parsed from the websites. The data may be gathered using API calls to the sources when available. The data may be imported and stored in the operations database on a scheduled basis, such as daily, weekly, monthly, quarterly, or some other regular or periodic interval. Alternatively, the data may be imported on-demand. The imported data may relate to any information pertaining to patents or patent applications, such as serial numbers, title, cited art, inventor or assignee details and the like.

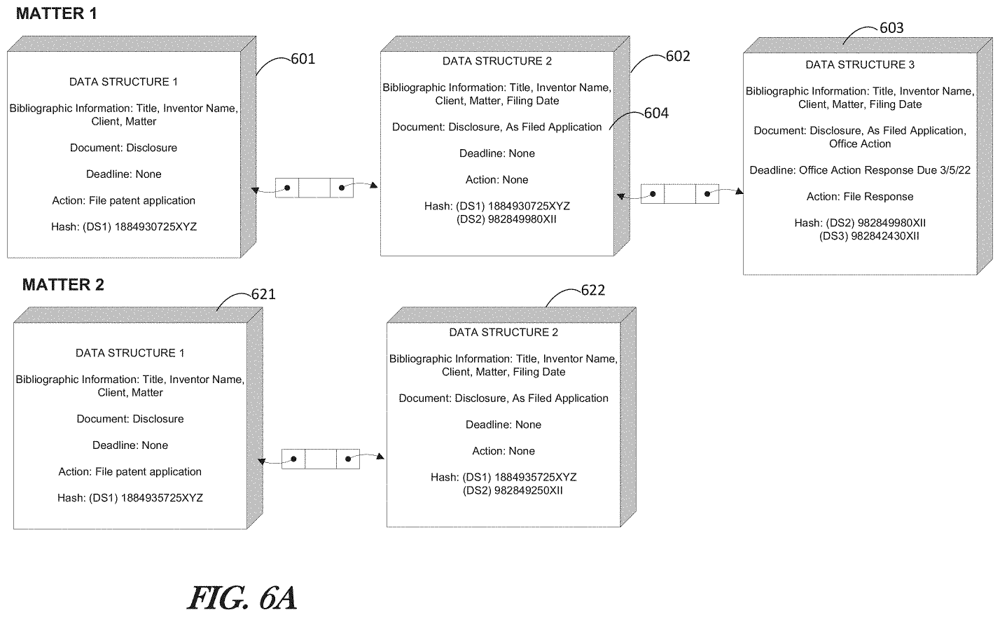

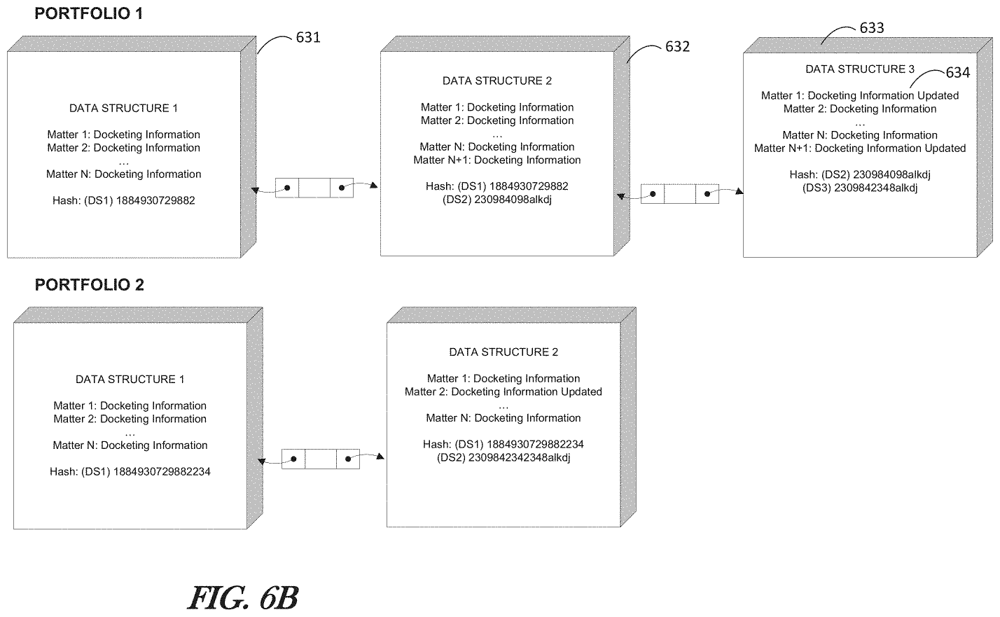

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats). In some embodiments, the imported data is stored in corresponding blockchain data structures. In other embodiments, data structures that maintain the integrity of the imported data may be generated after or during the data importation as a backup for the imported data. For example, docketing information for each matter or portfolio that is imported may be only stored in one or more data structures (e.g., a block or ledger entry may be created for the data that is imported using the imported docketing information) or may be stored in a database of the patent management system and also stored in one or more blockchain data structures. Exemplary data structures, used as a single source of docketing information or as a backup for docketing information stored in a database of the patent management system, are shown and described in connection with FIGS. 6A and 6B.

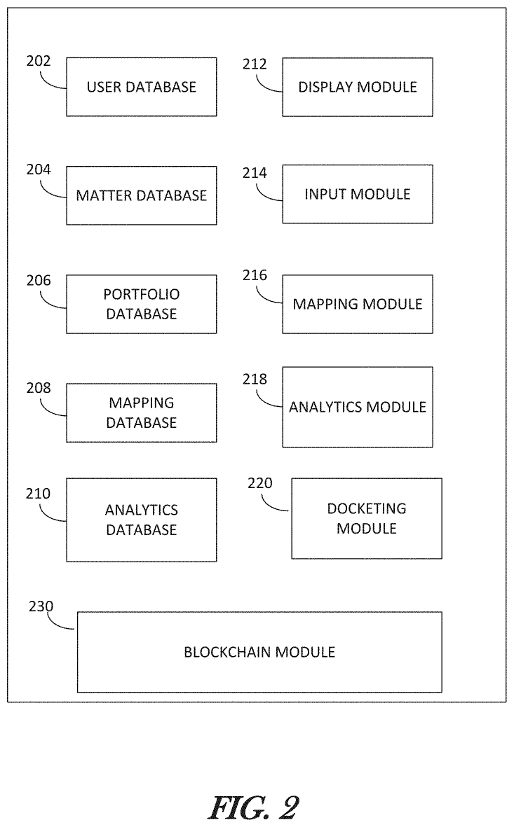

FIG. 2 is a block diagram of patent management system 102, according to an example embodiment. Illustrated are user database 202, matter database 204, portfolio database 206, mapping database 208, analytics database 210, display module 212, input module 214, mapping module 216, analytics module 218, docketing module 220, and blockchain module 230. The components illustrated in FIG. 2 may be implemented by one or more of the components shown in FIG. 1 for patent management system 102. In various embodiments, the data stored in databases 202, 204, 206, 208, and 210 and in blockchain module 230 may be in the same or multiple physical locations. Data stored in any of databases 202, 204, 206, 208 and 210 may be referred to as docketing information. In some embodiments, blockchain module 230 maintains the data stored in databases 202, 204, 206, 208 and 210 in the form of data structures in a blockchain as a single source or information for the patent management system or may store a duplicate copy or backup of the data stored in databases 202, 204, 206, 208 and 210 in the form of blockchain data structures. For example, portfolio database 206 may be stored in one or more computers associated with a portfolio management service. In various embodiments, patent management system 102 mirrors databases stored in other locations. In an embodiment, when a request is made to access data stored in the databases, patent management system 102 determines where the data is located and directs the request to the appropriate location. Similarly, modules 212, 214, 216, 218, 220 and 230 may be executed across multiple computer systems.

In an embodiment, matter database 204 stores docketing information representing matters as well as file histories, correspondences, and other documents related to patent matters. Each matter may be associated with one or more portfolios. In some embodiments, a matter is associated with no portfolios. In various embodiments, a matter is a foreign or domestic patent or application. Matters may also be inventions that have not yet been filed. In an embodiment, docketing information in a matter entry includes bibliographic fields representing a matter ID, patent number, publication number, serial number, docketing number, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, inventors of the matter, current owner of the matter, cited references on the face of the matter, filed date, issue date, docket number, customer or client instructions, and annuity information (e.g., due date, country, and amount due).

More or fewer data fields associated with a patent may be included in a matter entry stored in matter database 204. In an example embodiment, matter database 204 may store a patent matter database, wherein this database includes patent matter data and related documents and communications. For an example embodiment, a complete list of docketing activity templates is stored in a table in matter database 204 and/or analytics database 210. FIG, 6A shows example blockchain data structures for various matters stored in database 204. The blockchain data structures shown in FIG. 6A may be backups or duplicate copies of the docketing information stored in matter database 204. In another embodiment, the information stored in matter database 204 is organized in the form of blockchain data structures shown in FIG. 6A.

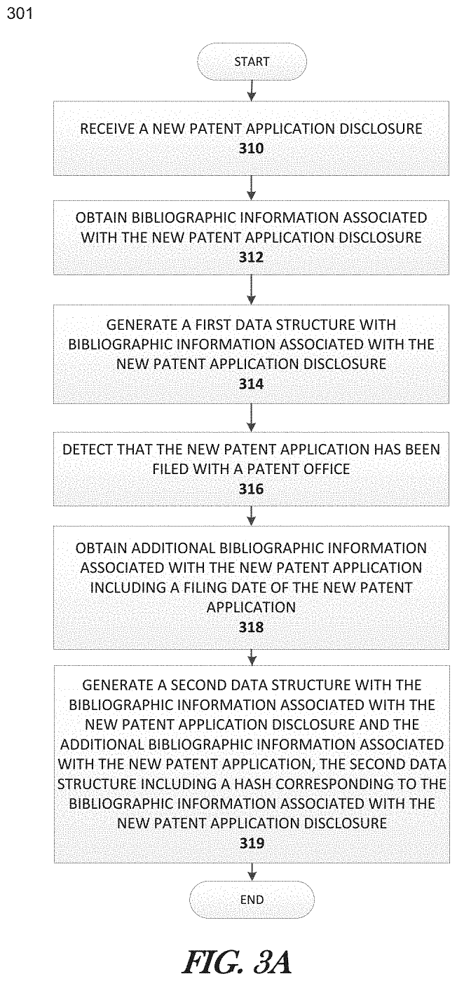

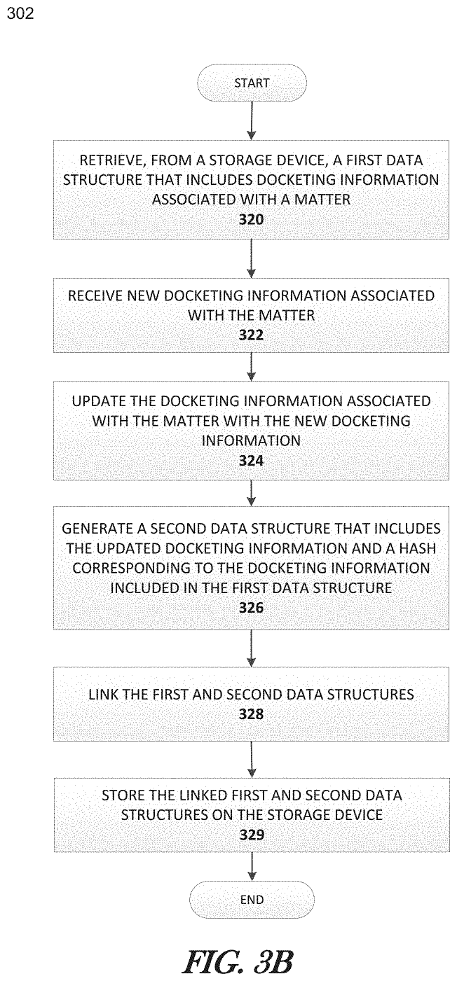

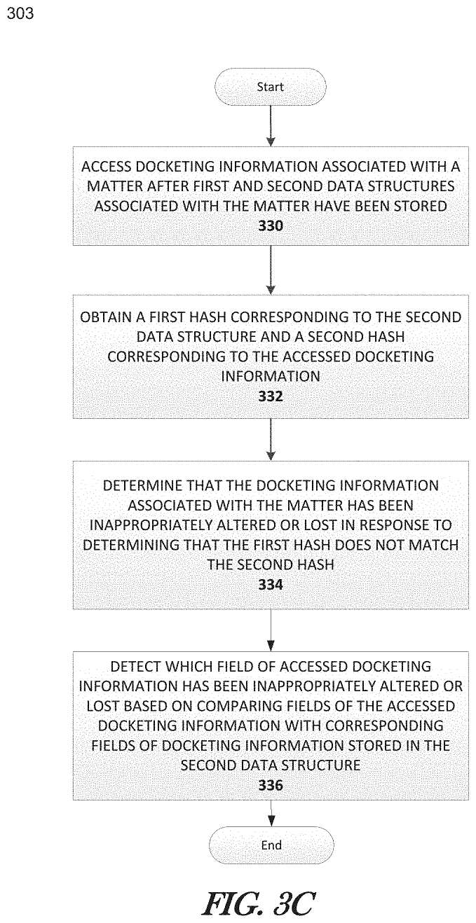

In various embodiments, the data is scraped and parsed from the websites if it is unavailable through a database. The data may be gathered using API calls to the sources when available. The data may be imported and stored in the operations database on a scheduled basis, such as daily, weekly, monthly, quarterly, or some other regular or periodic interval. Alternatively, the data may be imported on-demand. The imported data may relate to any docketing information pertaining to patents or patent applications, such as serial numbers, title, cited art, inventor or assignee details and the like. As the data is gathered, scraped, parsed and imported, new data structures may be added and linked for the corresponding matter or portfolio in the manner described in connection with FIGS. 3A and 3B.

In various embodiments, a matter is associated with one or more other matters as a family with a family ID. Family members may be priority documents, continuation patents/applications, divisional patents/applications, and foreign patent/application counterparts. In an embodiment, family information is determined according to an external source such as INPADOC. Patent reference documents and/or other prior art may be manually or automatically stored, cross-cited and associated with related family matters, for example.

Portfolio database 206, in an example embodiment, stores data representing portfolios of one or more matters. Data stored in portfolio database 206 may have been previously generated the patent management system 102. In various embodiments, a portfolio may be generated by a user using patent management system 102. For example, a user interface may be presented to the user requesting a name for the portfolio and identifiers of matters to be included in the portfolio. In an embodiment, a portfolio entry in portfolio database 206 includes the data fields of portfolio II) and portfolio name. Additionally, a data field for matter ID may also be included in an entry in the portfolio database. Thus, each portfolio may be associated with one or more matters through the use of the matter ID data field. More or fewer data fields associated with a portfolio may be included in a portfolio entry of portfolio database 206.

For various embodiments, a portfolio may represent all matters associated with a particular law firm, client, technology or other grouping of matters. By grouping portfolios in this manner, the docketing processes for docketing the next most probable docketing activity may be customized or tailored for a particular client or law firm. For example, a law firm managing portfolios of several clients, may decide to tailor their docketing process flows for the individual clients based on the client's internal intellectual property procedures. This may require the law firm to add customized docketing activity templates to track non-PTO activities. FIG. 6B shows example blockchain data structures for various portfolios stored in database 206. The blockchain data structures shown in FIG. 6B may be backups or duplicate copies of the docketing information stored in portfolio database 206. In another embodiment, the information stored in portfolio database 206 is organized in the form of blockchain data structures shown in FIG. 6B.

In various embodiments, mapping database 208 may include mappings of patent concepts to one or more matters. For example, the mapping module 216 is configured to facilitate mappings to associate at least one response due date or other date (e.g., date mailed) with the at least one downloaded document.

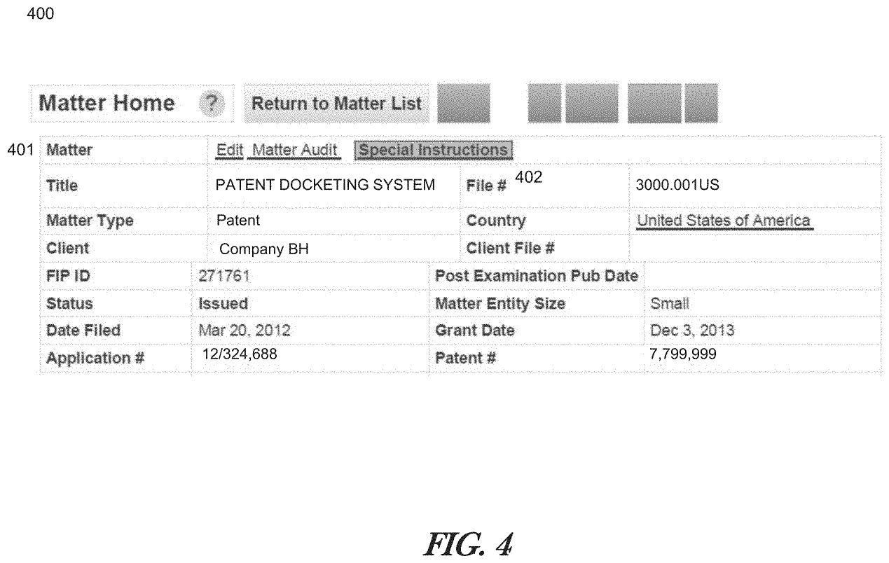

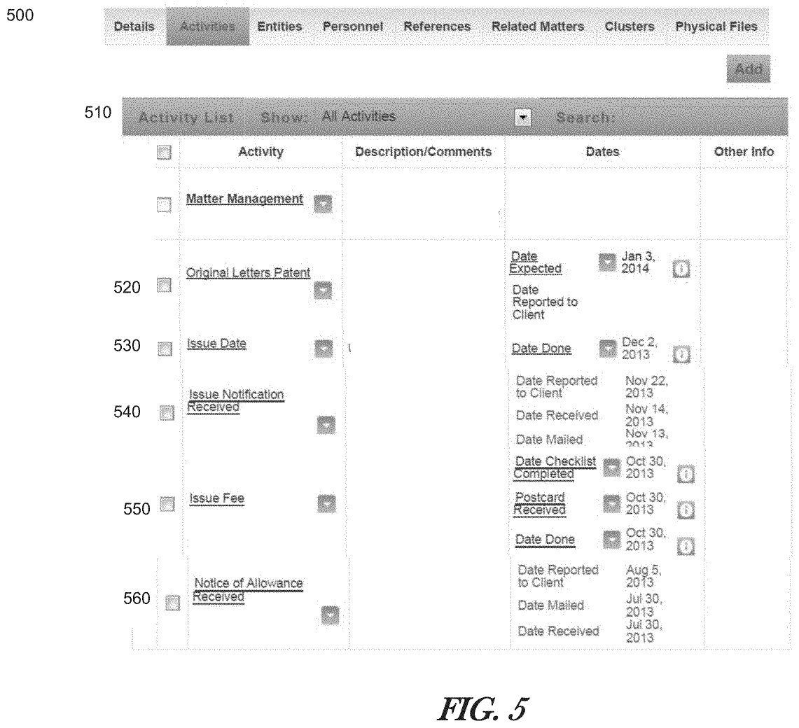

In an embodiment, display module 212 is configured to display user interfaces and information retrieved from one or more databases 202-210. If a user is accessing patent management system 102 remotely (e.g., through a web browser), display module 212, representing a user-interface through a network to a user terminal, may be configured to transmit data. In various embodiments, display module 212 may present patent matters bibliographic details, as shown in FIG. 4 and various docketing activities docketed including relevant dates for patent matters, as shown in FIG. 5. Furthermore, docketing data may be entered, through input module 214, into the user interface fields shown in FIGS. 4-5.

Docketing data entered through the user interface fields provided by display module 212 or via one or more API calls is referred to herein as docketing data that is “appropriately” entered. Namely, the data entered in this manner is reliable and has not been compromised. In these circumstances, data structures generated and maintained by blockchain module 230, may capture this docketing information and hashes maintained by these data structures are consistent with the entered information. The process performed by blockchain module 230 for generating and storing such data structures with docketing information is described below in connection with FIGS. 3A and 3B.

As explained in more detail below, blockchain module 230 generates data structures corresponding to patent matters and/or portfolios based on a blockchain. As used herein, a blockchain may comprise a data structure that stores a series of linked data blocks, where a data block in the series is linked to a prior block in the series, comprises a timestamp of blockchain creation, and comprises a hash (e.g., cryptographic hash of the contents) of the prior data block. In this way, the blockchain provides a chain of data blocks that makes it difficult to change a data block in the chain without compromising the integrity of the entire chain. Some embodiments described herein may use a blockchain as an electronic ledger that maintains a secure, historical record of data transactions relating to docketing information. As an electronic ledger, the blockchain may comprise a distributed ledger that may be accessed by two or more nodes. Some embodiments described herein may also add one more new data blocks to a blockchain to store data on the blockchain, for example, a data object, a hash of a data object, metadata regarding a data object, a public/private key used in performing data object transactions, or some combination thereof. For some embodiments, a plurality of nodes can access a common blockchain when performing data object functions described herein. Though the blockchain may be accessible by two or more nodes of an embodiment, one or more data objects stored on the blockchain may be encrypted before being stored on the blockchain as one or more data blocks. This can ensure that only those nodes associated with authorized users (e.g., those nodes having appropriate access rights or public keys) can access the encrypted data objects stored on the blockchain. Depending on the embodiment, the blockchain may be stored on a single or distributed datastore. For some embodiments, each node (e.g., client node) may be associated with its own blockchain.

In some circumstances, data maintained by matter database 204 or portfolio database 206 may be alerted, lost or tampered with in a manner other than by way of being appropriately entered. For example, the data may become corrupt or may be externally tampered with reducing its reliability and integrity. In these circumstances, new data structures representing these types of changes are not generated and linked to previous data structures. In addition, hash values generated based on the corrupt or tampered data in the matter may no longer match the hash values stored in the latest data structure corresponding to the matter (e.g., the last created block in the blockchain). Based on this data mismatch, blockchain module 230 determines that the data in the matter database 204 or portfolio database 206 has been compromised and can correct the information using data stored in the one of the data structures (e.g., one of the blocks in the blockchain) for the given matter or portfolio. The process for detecting and correcting such docketing information is described below in connection with FIG. 3C.

In various embodiments, input module 214 receives data from multiple sources where it may be further processed by one or more other modules and stored in one or more of databases 202-210. In various embodiments, input module 214 of the patent management system 102 may comprise a search engine (not shown) for conducting searches at a patent registry or on the Internet. For example, input module 214 may be configured to utilize one or more APIs to data from one or more patent data stores (e.g., public PAIR, private PAIR, INPADOC, foreign patent offices, patent docketing systems, portfolio management systems, etc.). The data may include published patent documents, patent applications, office actions or other patent office correspondences, prior art references, dockets dates, annuity payment data and patent or patent application assignment information. Specific assignment data may include details pertaining to the assignor or assignee (e.g. name, address, nationality, place of incorporation), date of assignment, details of the matter being assigned, or any other data pertaining to assignments or change in ownership that may be recorded at any national or regional patent registry such as the United. States Patent and Trademark Office (USPTO), World Intellectual Property Organization (WIPO) or European Patent Office (EPO), for example.

In various embodiments, input module 214 is configured to receive input from one or more user interface elements. For example patent management system 102 may present multiple user interfaces to a user. These user interfaces may enable users to input data directly into databases 202-210, instruct the patent management system to retrieve data from patent data stores, and instruct the patent management system to perform various operations (e.g., analysis) on the data in databases 202-210.

Additionally, input module 214 may be configured to determine the selection of one or more user interface elements by a user and initiate the action associated with the selected user interface element. In other example embodiments, input module 214 may be configured to receive user input to select patent matters and patent activity templates for docketing, and then provide the necessary information to update the patent activity templates to generate the docket due dates or other due dates to implement the user's patent management workflows.

In various embodiments, input module 214 processes the data that has been inputted and formats it according to the data fields of databases 202-210 as discussed above. In various embodiments processing is completed using a parsing module (not shown). For example, consider a patent publication that a user has directed to be inputted into one or more of the databases. The parsing module may use a combination of automatic image recognition and text analysis to determine the filing date, issue date, title, abstract, and claims of the patent. In some embodiments, the parsing module may flag certain pieces of data that had been determined to be potentially inaccurate (e.g., a number could not be read). A user of patent management system 102 may then examine the flagged data and manually enter the information which is then stored in the appropriate database.

The resulting data that has been parsed by the parsing module may then be entered as an entry in one or more of databases 202-210. This may be accomplished by, for example, formulating an insert SQL query with the parsed information. In various embodiments the parsing module may parse multiple pieces of information before generating a database entry. For example, input module 214 may receive a docket number for an issued patent. The docket number may be combined with the information parsed from the issued patent to form an entry in matter database 204. Docketing information provided using input module 214 is referred to as data that is appropriately entered resulting in new data structures being generated and linked by blockchain module 230. In some embodiments, as new data is entered using input module 214, blockchain module 230 generates new blockchain data structures. For example, if an issue date is updated using input module 214 for a given matter, blockchain module 230 identifies the blockchain of data structures for the given matter, generates a new data structure with the newly received docketing information, and links the newly generated blockchain data structure to the last data structure in the blockchain for the given matter.

in various embodiments, analytics module 218 is configured to examine and run calculations on the data stored in the databases 202-210 to generate the most probably next docketing activity. In an embodiment, the queries are formulated and run as requested by a user. In an embodiment, once the analytics information has been determined, it is stored within analytics database 210. In various embodiments, queries are formulated and run on a periodic basis (e.g., nightly) and entries in analytics database 210 may be updated to reflect any changes. Such changes are considered docketing information that is appropriately entered and result in new data structures being generated and linked by blockchain module 230.

In various embodiments, the docketing module 220 is configured to provide template-based docketing of activities for patent matters with country-law-based due date calculations and customizable workflows to automate docketing activities as needed. The docketing module 220 includes docketing activity templates for the various PTO activities and other templates for non-PTO activities for managing PTO and non-PTO due dates and activities, both of which can be pre-defined by the system or customized by users to implement the desired patent docketing workflows. Examples of non-PTO templates and docketing activities include the tracking of due dates for managing internal tasks within a law firm or corporate patent department, or tracking correspondences to-and-from foreign associates who are the registered agents for the patent matters in their respective PTO.

Several key decisions such as filing international applications or filing divisionals/continuations/CIPs, and annuity payment review can be triggered directly from docketing module 220. The docketing module 220 calculates the deadlines based on filing, prosecution, and grant dates for each patent matter or other prosecution dates (e.g., date mailed, date received, etc.), jurisdiction and applicable laws and applicable, and type of filing. Furthermore, the docketing module 220 is updated with the applicable country laws for all major countries as needed. Additionally, the docketing module 220, together with display module 212 and input module 214, provides an interface for users to appropriately input docketing data required (including the selection of the next most probable docketing activity) for docketing and due date generation into the relevant fields.

Tracking statutory deadlines and storing PTO correspondences is critical for managing patent portfolios effectively. Several PTO offices provide electronic data access for filing, prosecution, and maintenance-related activities, which can be accessed by the docketing module 220 via input module 214, which may have an electronic interface, such as an API, for fully or partially automating the downloading of documents and correspondences from the PTOs and/or uploading and docketing in the user's patent management or docketing system. The PTO correspondences are stored in matter database 204 and can be retrieved thru input module 214 by the user.

Patent docketing systems may be maintained or updated automatically, as described above, or by patent docketing specialists who performs docketing and upload documents and correspondences into the patent management system 102 as PTO correspondences are received. Furthermore, the patent management system needs to be updated with information and docketing activities as patent attorneys, agents or paralegals complete patent activities, such as filing various responses with the U.S. PTO. The patent docketing process requires trained patent docketing specialists, who understand the patent lifecycle and PTO rules and regulations to properly docketed patent matters as responses or other documents are filed with the PTO, or received from the PTO, to docket PTO activities. Other non-PTO activities may also be important to docket, for example, law firms docket their internal processes for implementing their client requested procedures or correspondences with foreign associates who communicate and file responses directly with their respective foreign patent offices.

One of the challenges in maintaining a patent management system is maintaining integrity of the data stored in this system to ensure the data is reliable, accurate and not susceptible to inappropriate or unverified changes. Embodiments of the present specification maintain such data integrity and reliability by using data structures in the form of a blockchain. In particular, each appropriate or approved change in the patent management system is reflected in a new data structure that is linked to a previous data structure associated with a matter or portfolio. The new data structure includes a hash of the previous data structure pertaining to the same matter or portfolio. Because the data structures maintain hashes of the docketing information stored by previous data structures, inappropriate changes can be detected because inappropriate changes would not match the hashes stored in the data structures. For example, if at a given time, the data in the patent management system is comprised, a hash of docketing information of the compromised data will no longer match the hash stored in the latest data structure for the matter or portfolio. Because of this mismatch, the docketing information can be determined to be compromised and data stored in the blockchain for the matter or portfolio can be used to replace or correct the compromised docketing information.

Some embodiments of the present inventive subject matter include processes for aspects of patent management. Block diagrams of such processes are shown in FIGS. 3A-3C.

FIG. 3A is a block diagram showing a process for maintaining data integrity in the patent management system, according to example embodiments. The process of FIG. 3A represents docketing information stored in the blockchain data structures as a backup of the docketing information stored in a database of the patent management system.

At operation 310, a new patent application disclosure is received. For example, a new matter may be created in the patent management system with a unique ID corresponding to the new disclosure. The patent application disclosure document may be uploaded from an external source to the matter in the patent management system (e.g., using input module 214). This document is stored as docketing information of the matter in the patent management system, for example in matter database 204.

At operation 312, bibliographic information associated with the new patent application disclosure is obtained. This bibliographic information may be stored in a bibliographic field of the docketing information associated with the matter. For example, analytics module 218 may perform image analysis on the content of the patent application disclosure document to obtain bibliographic information. Alternatively, or in addition, the bibliographic information may be input using input module 214 into the corresponding matter in the patent management system. In particular, any field shown and described below in connection with FIG. 4, including inventor information, invention title, file number, etc., may be stored in a bibliographic information field of the docketing information associated with the matter in the operations database 116.

At operation 314, a first data structure with bibliographic information associated with the new patent application disclosure is generated. For example, blockchain module 230 may process the bibliographic information stored in the bibliographic field of the docketing information in flatter database 204 and generate a data structure that includes this information. Blockchain module 230 may also add the disclosure document to the generated data structure. Blockchain module 230 may obtain a hashing function and a private key and generate a hash based on the docketing information added to the data structure. This hash may be stored in the data structure. An example first data structure 601 for a given matter is shown in FIG. 6A. In some implementations, first data structure 601 may include other docketing information fields that are empty if no information is available (e.g., a filing date and issue date). In some implementations, the first data structure 601 may be encrypted before being stored. First data structure 601 may include information that is duplicative as a backup of the docketing information in the matter database 204 for the given matter.

At operation 316, a new patent application being filed with a patent office is detected. For example, blockchain module 230 may communicate with analytics module 218 or any other module to periodically or in real-time receive updates for various matters. Upon detecting a change associated with a given matter, blockchain module 230 may obtain docketing information associated with the change and generate a new data structure to be added to the blockchain of the matter. For example, at operation 318, blockchain module 230 may obtain additional bibliographic information associated with the new patent application including a filing date of the new patent application from matter database 204. For example, blockchain module 230 may obtain a timestamp representing the last update to the matter in the blockchain and compare this timestamp to a timestamp stored in the matter database 204 indicating the time when information was updated in the matter database 204 for the matter. If the timestamp of the matter in the blockchain precedes the timestamp of the matter in database 204, blockchain module 230 may determine that an update to the blockchain data structures is needed. In this case, blockchain module 230 may compare each field of docketing information stored in the latest data structure for the matter with each field of docketing information stored in matter database 204. In response to detecting a difference in one of the fields (e.g., additional bibliographic information), blockchain module may generate and link a new blockchain data structure with the new docketing information. Accordingly, the new blockchain data structure may reflect the latest docketing information for the matter stored in database 204.

At operation 319, a second data structure with bibliographic information associated with the new patent application disclosure and the additional bibliographic information associated with the new patent application is generated. The second data structure includes a hash corresponding to the bibliographic information associated with the new patent application disclosure. For example, blockchain module 230 may generate a new data structure that includes the filing date and a copy of the patent application that was filed 604 as the docketing information.

Blockchain module 230 may obtain from the first data structure 610 the hash stored in the first data structure 610 (blockchain module 230 may first decrypt the first data structure if the data structure is encrypted to obtain the hash). Blockchain module 230 may add the hash obtained from the first data structure 610 to the second data structure 602 to link the two data structures in the blockchain. In some implementations, blockchain module 230 may generate a hash, based on a private key, using a hashing function of the docketing information stored in the second data structure 602 and the hash obtained from the first data structure 601. For example, the second data structure 602 may store two hash values, one that is a copy of the hash of the contents of the first data structure 601 and a second that is generated based on the copy of the hash of the first data structure 601 hash and the contents of the second data structure 602. Blockchain module 230 may store a reference in the first data structure 601 to the second data structure 602 and may store a reference in the second data structure 602 to the first data structure 601 to link the two data structures.

The generation of the second data structure performed at operation 319 may be performed for each individual update or change in the docketing information, after a predetermined number of changes are detected, or after a predetermined time interval. For example, if the filing date and the uploading of a patent application document are the detected changes in the docket information, two additional data structures may be generated and added to the blockchain data structures. A first additional data structure may be added reflecting only the filing date and a second additional data structure may be added reflecting the contents of the first additional data structure and the uploaded patent application document. Alternatively, an additional data structure may be generated after two changes are detected. In this case, one additional data structure may be generated and linked in the blockchain reflecting both changes (e.g., the filing date being added and the uploading of the patent application document). Alternatively, a new blockchain data structure may be generated after every 5 minutes (if new changes are detected). In this case, one additional data structure may be generated and linked in the blockchain reflecting both the filing date and the uploading of the patent application document if both of these changes are detected within the same 5 minute interval.

Blockchain module 230 may continue to periodically or in real-time receive updates to matters from docketing module 220. Blockchain module 230 may add additional data structures 603 in a similar manner including any additional updates and hashes of previous data structures. Blockchain module 230 may perform similar processes for other matters to generate data structures 621 and 622 for other matters in the portfolio in a blockchain.

FIG. 3B is a block diagram showing a process for maintaining data integrity in the patent management system, according to example embodiments. FIG. 3B shows a process for the docketing information in the blockchain data structure being the single source of docketing information for the patent management system.

At operation 320, a first data structure that includes docketing information associated with a matter is retrieved. For example, blockchain module 230 may retrieve from a storage device a second data structure 602 associated with a first matter.

At operation 322, new docketing information associated with the first matter is received. For example, blockchain module 230 may receive from analytics module 218 an indication that an Office Action has been received along with an issue date and deadline associated with the Office Action.

At operation 324, the docketing information associated with the matter is updated with the new docketing information. For example, the first data structure 602 may include an empty deadline and action field because no activities are due for the matter. After receiving the new docketing information including the Office Action issued in the matter, blockchain module 230 may update these fields in a third data structure 603 with information about the Office Action (e.g., the issue date and the deadline for responding to the Office Action).

At operation 326, blockchain module 230 may generate a third data structure 603 that includes the updated docketing information. For example, the third data structure 603 includes the docketing information associated with the Office Action issued in connection with the first matter. The third data structure 603 may also include a hash of the second data structure 602. Blockchain module 230 may obtain from the second data structure 602 the hash stored in the second data structure 602 (blockchain module 230 may first decrypt the second data structure 602 if the data structure is encrypted to obtain the hash). Blockchain module 230 may add the hash obtained from the second data structure 602 to the third data structure 603. In some implementations, blockchain module 230 may generate a hash, based on a private key, using a hashing function of the docketing information stored in the third data structure 603 and the hash obtained from the second data structure 602. For example, blockchain module 602 may combine the hash obtained from second data structure 602 and the docketing information in the third data structure 603, apply a cryptographic private key to the combined data, and generate a hash for the third data structure 603 based on this combined data and the private key.

At operation 328, the first and second data structures are linked. For example, blockchain module 230 may store a reference in the second data structure 602 to the third data structure 603 and may store a reference in the third data structure 603 to the second data structure 602 to link the two data structures. At operation 329, the linked first and second data structures are stored on a storage device.

In some implementations, blockchain module 230 may perform the generation, linking and storage of the data structures in the blockchain for each portfolio. This may be beneficial in detecting changes and inappropriate or corrupt data on a portfolio wide basis. In some implementations, blockchain module 230 may maintain a portfolio based blockchain of data structures and matter based blockchain of data structures. In other implementations, blockchain module 230 may maintain only a portfolio blockchain of data structures or matter specific blockchain of data structures.

In some implementations, blockchain module 230 may generate and link a new data structure (e.g., a new block in the blockchain) only after verifying that the last data structure in the chain is not corrupt or has not been tampered with. In some implementations, this verification may be performed in the manner discussed below in connection with FIG. 3C. In particular, blockchain module 230, in response to detecting a need to generate a new data structure to be linked (e.g., because new docketing information has been received or a change to docketing information has been detected for a matter or portfolio), may retrieve the last data structure in the chain. Blockchain module 230 may generate a hash of the docketing information stored in the retrieved data structure (and if necessary any docketing information stored in previous data structures). Particularly, blockchain module 230 may generate a hash in the same way and using the same docketing information field that were used to generate the hash that is stored in the last data structure in the chain. Blockchain module 230 may then compare the generated hash with the hash previously stored in the data structure. In response to determining that the two hash values match, blockchain module 230 may confirm that the data has not been tampered with and is not corrupt. At this stage, blockchain module may proceed to perform operations or 319 or 326 as discussed above.

Each portfolio may include a separate blockchain of portfolio data structures as shown in FIG. 6B. :Each of the data structures in the portfolio blockchain may include all or a portion of the docketing information of the each of the matters in the portfolio. As docketing information is updated in each given matter of the portfolio, additional portfolio data structures are generated and added to the portfolio blockchain. For example, a first portfolio data structure 631 may include docketing information for matters 1−N associated with the first portfolio. After detecting a change in the first portfolio (e.g., addition of a new matter in the first portfolio), blockchain module 230 may generate and link a new second portfolio data structure 632 to the first portfolio data structure 631. The second portfolio data structure 632 may include docketing information for matters 1−N+1 and may include a hash of the docketing information in the first portfolio data structure 631. The first and second portfolio data structures 631 and 632 may include references to each other. In some implementations, after detecting a change in the first portfolio (e.g., updated docketing information for a matter), blockchain module 230 may generate and link a new third portfolio data structure 633 to the second portfolio data structure 632. The third portfolio data structure 633 may include the updated docketing information 634 for matter 1 and matter N+1 and may include a hash of the docketing information in the second portfolio data structure 632. The second and third portfolio data structures 632 and 633 may include references to each other and are thereby linked.

In some embodiments, blockchain module 230 maintains a backup of the docketing data in databases 204/206. In these cases, blockchain module 230 may monitor matter database 204 or portfolio database 206 and compare hashes of docketing data contained in those databases to hashes stored in the data structures of the blockchain. in response to detecting a mismatch in the hashes, blockchain module 230 may determine that the docketing information stored in database 204/206 has been compromised. In such cases, blockchain module 230 may search the data structures in the portfolio or matter in which the mismatch was detected to identify which docketing information fields have been compromised and to correct the docketing information. In other embodiments, blockchain module 230 maintains the single copy and is the single source of docketing information for the patent management system. In this case, blockchain module 230 may routinely or periodically generate hashes of the docketing information contained in the latest block in the blockchain for a matter or portfolio. Blockchain module 230 compare the generated hash to the stored hash in the last blockchain data structure to determine if the data provided by the last blockchain data structure has been compromised. FIG. 3C below describes a process 303 for performing such monitoring and correction according to these two embodiments.

At operation 330, docketing information associated with a matter is accessed after first and second data structures associated with the matter have been stored. For example, at predetermined intervals or routinely, blockchain module 230 may select a given matter or portfolio to check for data integrity. For example, blockchain module 230 may select a second matter to examine for data integrity. In one embodiment, when blockchain module 230 maintains a backup of the docketing information stored in databases 204/206, blockchain module 230 may communicate with matter database 204 to obtain docketing information for the second matter. For example, blockchain module 230 may obtain a file number or unique ID of the second matter and retrieve from matter database 204 the docket information of the second matter. This operation may be performed after data structures 621 and 622 associated with the second matter have been stored. In another embodiment, blockchain module 230 may retrieve the docketing information for the second matter from the latest data structure (e.g., data structure 622) in the blockchain for the second matter.

At operation 332, a first hash corresponding to the second data structure and a second hash corresponding to the accessed docketing information are obtained. For example, blockchain module 230 may retrieve the stored hash (DS2) of the docketing information contained in latest data structure 622 to obtain the first hash. As discussed above, the stored hash (DS2) may have been previously generated, using a private key, by combining the hash of the docketing information stored in the previous data structure 621 with the docketing information stored in the latest data structure 622.

The second hash may be obtained either based on the docketing information obtained from database 204/206 (in case the blockchain acts as a backup for this data) or based on the docketing information stored in the latest blockchain data structure 622 itself. For example, blockchain module 230 may access the hashing function and private key and perform a hash of the data obtained from flatter database 204 in combination with the hash (DS1) to obtain the second hash corresponding to the accessed docketing information. In another embodiment, blockchain module 230 may obtain, from the latest data structure 622, the hash (DS1), of the docketing information contained in the previous data structure 621 that is linked to the latest data structure 622, and perform a hash of the docketing information in the latest data structure 622 in combination with the hash (DS1) to obtain the second hash.

At operation 334, a determination is made that the docketing information associated with the matter has been inappropriately altered or lost in response to determining that the first hash does not match the second hash. For example, blockchain module 230 may compare the first hash (DS2, retrieved from the latest data structure 622) with the hash generated based on the obtained docketing information from matter database 204 or data structure 622. In particular, blockchain module 230 may subtract each of the hash values to determine if the result is non-zero. If the result is non-zero, blockchain module 230 may determine that the hash values do not match. As a result, blockchain module 230 may determine that the data of the second matter has been compromised and may output an alert to display module 212 to notify an operator or user.

In an example, if the docketing information contained in the latest data structure 622 has been inappropriately changed, the hash value (DS2) of the latest data structure 622 will not correspond to the inappropriate changes. This is because hash value DS2 was changed based on one set of docketing information and a hash of a previous block. Any change in this docketing information without updating the corresponding hash will result in a hash that no longer matches the previously stored hash value DS2. In some implementations, the hashing function may be computed using a private key to prevent an unauthorized entity from being able to change the docketing information and generate the correct hash value. That is, an unauthorized entity may attempt to change the docketing information but without the private key, the unauthorized entity will not be able to change the hash value to correctly reflect the changed docketing information. Accordingly, unauthorized changes to docketing information can be detected by computing a hash of the latest docketing information using the private key and determining whether the hash matches the previously stored hash of the docketing information stored in the latest data structure 622. For example, an unauthorized person may modify a customer instructions field or annuity field of a given matter. Such modification may change the corresponding data contained in the customer instructions field or annuity field of the blockchain data structure. But because the unauthorized person does not know the private key, the unauthorized person does not change the has in the blockchain data structure that contains the customer instructions field or annuity field. As a result, a hash computed based on the unauthorized change will not match the hash stored in the blockchain data structure. This indicates that the data has been compromised and the data can be corrected by access a previous blockchain data structure for the matter according to the disclosed process.

At operation 336, a detection is made as to which field of the accessed docketing information has been inappropriately altered or lost based on comparing fields of the accessed docketing information with corresponding fields of docketing information stored in the second data structure. For example, when blockchain module 230 acts as a backup of the docketing information stored in database 204/206, blockchain module 230 may perform a field by field comparison of the docketing information contained in the latest data structure 622 (which has not been tampered with) with the docketing information retrieved from matter database 204 or portfolio database 206. Any differences in the fields may indicate compromised docketing information for such fields. In such cases, blockchain module 230 may replace the docketing information in the fields of matter database 204 that are different from the fields of the docketing information in the latest data structure 622 with the data from the fields of latest data structure 622.

In some implementations, when blockchain module 230 is the single source of docketing information, blockchain module 230 may determine that the docketing information in the latest data structure 622 no longer generates a hash that matches the hash DS2 stored in the latest data structure 622. In such circumstances, blockchain module 230 may determine that the docketing information in the latest data structure 622. has been compromised and accesses a previous data structure 621 to determine if docketing information in the previous data structure 621 has been compromised in a similar manner as discussed above. In particular, blockchain module 230 may compute a hash of the docketing information contained in the previous data structure 621. This computed hash may be compared with the hash stored in the previous data structure 621 to determine if the hash values match. If they match, blockchain module 230 may determine that the docketing information in the previous data structure 621 has not been compromised and may discard the latest data structure 622 and/or notify an operator via display module 212 to correct the data.

In some implementations, when blockchain module 230 determines that the docketing information in the latest data structure 622 has been compromised, blockchain module 230 may compare fields of the docketing information in the previous data structure 621 with the fields of docketing information in the latest data structure 622. Difference between fields may be flagged as potentially compromised. These different fields may be output via display module 212 for an operator to verify and correct potentially compromised. docketing data. After the operator corrects the data, the latest data structure 622 is discarded, a new data structure is generated based on the previous data structure 621 and the corrected data including the hash of the previous data structure 621 in a similar manner as discussed above. This new data structure includes a reference to the previous data structure 621 and the previous data structure 621 includes a reference to the new data structure instead of the latest data structure 622.

The operations discussed above in connection with FIG. 3C may be similarly performed to detect and correct changes on a portfolio wide basis based on portfolio data structures shown in FIG. 6B.

FIG. 4 illustrates a user interface 400 for presenting patent matter details of a matter, according to an example embodiment. The user interface 400 represents a matter having various fields. The matter shown in user interface 400 has a Title field 401 representing the title of the matter and a File # field 402 representing the file number of the matter. Although the File # is the most common way to select a matter in user interface 400, other fields such as Title, Patent #, etc. can be used to select a matter for docketing. Various other matter detail fields are shown by user interface 400 such as the Matter Type, Country, Client, Client File #, Status, Matter Entity Size, Date Filed, Grant Date, Application # and Patent #. The matter detail fields are referred to as docketing information. In some embodiments, compromised data is presented to an operator via user interface 400 for correction and generation of new data structures for a matter or portfolio blockchain.

FIG. 5 illustrates a user interface 500 for presenting docketing activities in a patent matter. As shown by user interface 500, the activities tab is selected, which provides a list of activities 510 for a patent matter. The following are patent docketing activities: Original Letters Patent 520, Issue Date 530; Issue Notification Received 540; Issue Fee 550; and Notice of Allowance Received 560. Each of the docketing activities listed below has a one or more corresponding dates. The docketing activities, Notice of Allowance Received 560 and Issue Notification Received 540 represent correspondences received from the U.S. PTO with corresponding due dates. The docketing activity Issue Fee 550 represents an action required by a user, such as a patent owner or legal representative of the patent owner. Each of the docketing activities 520, 530, 540, 550 and 560 has a corresponding docketing activity template (not shown). In some embodiments, compromised data is presented to an operator via user interface 500 for correction and generation of new data structures for a matter or portfolio blockchain.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

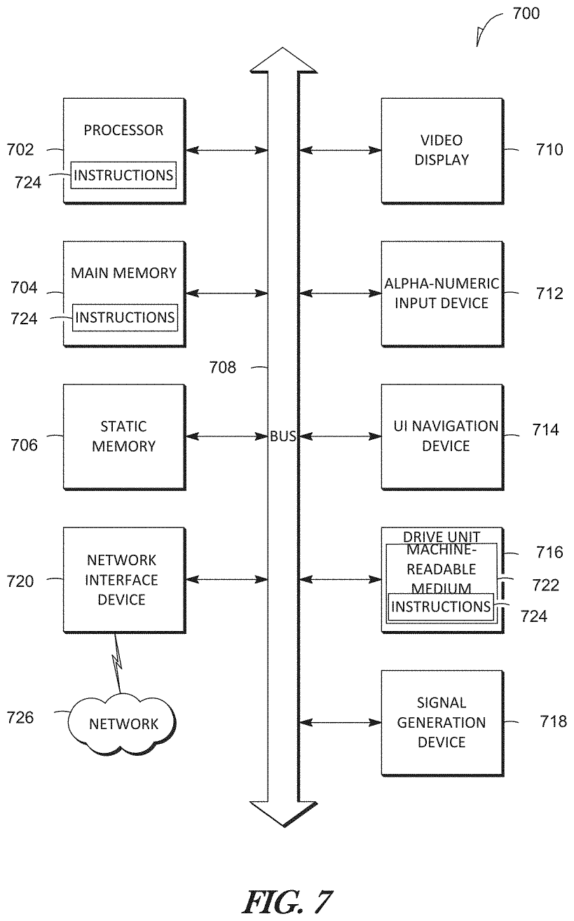

FIG. 7 is a block diagram of machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top block (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### Note on the Abstract

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method maintaining docketing data integrity, the method comprising:
retrieving, from a storage device, a first data structure that includes docketing information associated with a matter;
receiving new docketing information associated with the matter;
updating the docketing information associated with the matter with the new docketing information;
generating a second data structure that includes the updated docketing information and a hash corresponding to the docketing information included in the first data structure;
linking the first and second data structures; and
storing the linked first and second data structures on the storage device.

2. The method of claim 1, wherein the hash included in the second data structure is a first hash, further comprising:
generating a second hash corresponding to the updated docketing information; and
adding the second hash to the second data structure.

3. The method of claim 1, wherein fields in the first data structure include at least one of bibliographic information, a document, an action, and a deadline associated with the matter, and wherein receiving the new docketing information comprises receiving a modification to the at least one of the bibliographic information, the document, the action, and the deadline associated with the matter.

4. The method of claim 1 further comprising:
receiving a new patent application disclosure;
obtaining bibliographic information associated with the new patent application disclosure;
generating the first data structure with the bibliographic information associated with the new patent application disclosure;
detecting that the new patent application has been filed with a patent office; and
in response to the detecting:
obtaining additional bibliographic information associated with the new patent application including a filing date of the new patent application; and
generating the second data structure with the bibliographic information associated with the new patent application disclosure and the additional bibliographic information associated with the new patent application, the second data structure including the hash corresponding to the bibliographic information associated with the new patent application disclosure.

5. The method of claim 1, wherein the second data structure is generated after at least one of a predetermined number of new docketing information has been received, a predetermined time interval, termination of a client session, or verifying that the docketing information stored in the first data structure has not been inappropriately altered or lost.

6. The method of claim 1 further comprising monitoring multiple data structures stored on the storage device for multiple matters to determine whether data associated with a given one of the matters has been inappropriately altered or lost.

7. The method of claim 6, wherein the monitoring comprises:
accessing docketing information associated with the matter after the second data structure is stored;
obtaining a first hash corresponding to the second data structure and a second hash corresponding to the accessed docketing information; and
determining that the docketing information associated with the matter has been inappropriately altered or lost in response to determining that the first hash does not match the second hash.

8. The method of claim 7 further comprising:
comparing fields of the accessed docketing information with corresponding fields of docketing information stored in the second data structure; and
detecting which of the fields of the accessed docketing information has been inappropriately altered or lost based on the comparing.

9. The method of claim 7 further comprising in response to determining that the first hash matches the second hash:
obtaining a third hash corresponding to the first data structure;
obtaining a fourth hash corresponding to fields of the accessed docketing information that are included in the docketing information of the first data structure; and
determining that the docketing information associated with the matter has not been inappropriately altered or lost in response to determining that the third hash matches the fourth hash.

10. The method of claim 1 further comprising storing a portfolio data structure comprising first and second portfolio data structures, the first portfolio data structure including a first collection of docketing information for each matter in the portfolio, the second portfolio data structure including a second collection of docketing information for each matter in the portfolio and a hash corresponding to the first portfolio data structure, where the second collection of docketing information is updated with respect to the first collection of docketing information.

11. A patent management system comprising:
at least one patent database, accessible via a network, and storing data including docketing information for at least one matter stored in the database; and
a server, operatively connected to the network, wherein the serve includes:
a processor; and
a memory; and
the processor configured to:
retrieve, from the at least one patent database, a first data structure that includes docketing information associated with the at least one matter;
receive new docketing information associated with the at least one matter:
update the docketing information associated with the at least one matter with the new docketing information;
generate a second data structure that includes the updated docketing information and a hash corresponding to the docketing information included in the first data structure;
link the first and second data structures; and
store the linked first and second data structures on the patent database.

12. The patent management system of claim 11, wherein the hash included in the second data structure is a first hash, and wherein the processor is further configured to:
generate a second hash corresponding to the updated docketing information; and
add the second hash to the second data structure.

13. The patent management system of claim 11, wherein fields in the first data structure include at least one of bibliographic information, a document, an action, and a deadline associated with the matter, and wherein receiving the new docketing information comprises receiving a modification to the at least one of the bibliographic information, the document, the action, and the deadline associated with the matter.

14. The patent management system of claim 11, wherein the processor is further configured to:
receive a new patent application disclosure;
obtain bibliographic information associated with the new patent application disclosure;
generate the first data structure with the bibliographic information associated with the new patent application disclosure;
detect that the new patent application has been filed with a patent office; and
in response to the detecting:
obtain additional bibliographic information associated with the new patent application including a filing date of the new patent application; and
generate the second data structure with the bibliographic information associated with the new patent application disclosure and the additional bibliographic information associated with the new patent application, the second data structure including the hash corresponding to the bibliographic information associated with the new patent application disclosure.

15. The patent management system of claim 11, wherein the second data structure is generated after at least one of a predetermined number of new docketing information has been received, a predetermined time interval, termination of a client session, or verifying that the docketing information stored in the first data structure has not been inappropriately altered or lost.

16. The patent management system of claim 11, wherein the processor is further configured to monitor multiple data structures stored on the storage device for multiple matters to determine whether data associated with a given one of the matters has been inappropriately altered or lost.

17. The patent management system of claim 16, wherein the processor is further configured to perform the monitoring by:
accessing docketing information associated with the matter after the second data structure is stored;
obtaining a first hash corresponding to the second data structure and a second hash corresponding to the accessed docketing information; and
determining that the docketing information associated with the matter has been inappropriately altered or lost in response to determining that the first hash does not match the second hash.

18. The patent management system of claim 17, wherein the processor is further configured to:
compare fields of the accessed docketing information with corresponding fields of docketing information stored in the second data structure; and
detect which of the fields of the accessed docketing information has been inappropriately altered or lost based on the comparing.

19. The patent management system of claim 17, wherein the processor is further configured to in response to determining that the first hash matches the second hash:
obtain a third hash corresponding to the first data structure;
obtain a fourth hash corresponding to fields of the accessed docketing information that are included in the docketing information of the first data structure; and
determine that the docketing information associated with the matter has not been inappropriately altered or lost in response to determining that the third hash matches the fourth hash.

20. The patent management system of claim 11, wherein the processor is further configured to store a portfolio data structure comprising first and second portfolio data structures, the first portfolio data structure including a first collection of docketing information for each matter in the portfolio, the second portfolio data structure including a second collection of docketing information for each matter in the portfolio and a hash corresponding to the first portfolio data structure, where the second collection of docketing information is updated with respect to the first collection of docketing information.
